(19) United States
(12) Patent Application Publication
(10) Pub. No.: US 2020/0072420 A1
(43) Pub. Date: Mar. 5, 2020

(54) SYSTEMS AND METHODS FOR HEATING EQUIPMENT IN HAZARDOUS ENVIRONMENTS

(71) Applicant: TECH DESIGN LLC, Maryland Heights, MO (US)

(72) Inventor: O. Stephan Irgens, St. Charles, MO (US)

(21) Appl. No.: 16/466,077

(22) PCT Filed: Nov. 27, 2017
(86) PCT No.: PCT/US17/63241

§ 371 Date: Jun. 3, 2019

Related U.S. Application Data
(60) Provisional application No. 62/430,090, filed on Dec. 5, 2016.

(51) Int. Cl. F17D 1/18; F17D 5/00; F16L 53/35; H05B 1/02; H05B 3/34

(52) U.S. Cl. CPC F17D 1/18; F17D 5/005; H05B 2203/02; H05B 1/0244; H05B 3/34; F16L 53/35

(57) ABSTRACT

A system for heating equipment in a hazardous environment is provided. The system includes a control system configured to receive power from a power source, a heating pad configured to heat the equipment, the heating pad including at least one heating element, wherein the at least one heating element is a flexible semi-conductive self-regulating heating element, at least one thermal insulation layer positioned on one side of the at least one heating element, and a protective cover, wherein the at least one heating element and the at least one thermal insulation layer are sealed within the protective cover, and a power cable coupling the control system to the heating pad.

### CROSS REFERENCE TO RELATED APPLICATIONS

This application claims the benefit of U.S. Provisional Patent Application No. 62/430,090 filed Dec. 5, 2016, which is hereby incorporated by reference in its entirety.

### BACKGROUND OF THE DISCLOSURE

This invention relates to heating equipment in hazardous environments, and in particular to an intrinsically safe heating pad including flexible semi-conductive self-regulating heating elements.

Equipment, such as liquid gas pipelines, may need to be heated to reduce or eliminate operational failures and interruption of production. For example, a sudden pressure drop or low ambient temperatures may cause liquid gas within a pipeline to at least partially solidify, reducing throughput of the pipeline. Further, low ambient temperatures may also cause ice to form on equipment, damaging or impacting operation of the equipment.

At least some known heating systems require a temperature sensor located in a hazardous environment (e.g., at a pipeline) to monitor/regulate heating. However, it may be costly and inefficient to transmit sensor readings from the temperature sensor to a remotely located control system. Accordingly, it would be desirable to provide a versatile and intrinsically safe heating device that may be used in hazardous environments without requiring a temperature sensor.

### BRIEF DESCRIPTION OF THE DISCLOSURE

In one aspect, a system for heating equipment in a hazardous environment is provided. The system includes a control system configured to receive power from a power source, a heating pad configured to heat the equipment, the heating pad including at least one heating element, wherein the at least one heating element is a flexible semi-conductive self-regulating heating element, at least one thermal insulation layer positioned on one side of the at least one heating element, and a protective cover, wherein the at least one heating element and the at least one thermal insulation layer are sealed within the protective cover, and a power cable coupling the control system to the heating pad.

In another aspect, a heating pad for heating equipment in a hazardous environment is provided. The heating pad includes at least one heating element, wherein the at least one heating element is a flexible semi-conductive self-regulating heating element, at least one thermal insulation layer positioned on one side of the at least one heating element, and a protective cover, wherein the at least one heating element and the at least one thermal insulation layer are sealed within the protective cover.

### BRIEF DESCRIPTION OF THE DRAWINGS

FIG. 1 is a schematic diagram of an example heating system.

FIG. 2 is a perspective partial cut-away view of a heating pad that may be used with the system shown in FIG. 1.

FIG. 3 is a cross-sectional view of a heating pad that may be used with the system shown in FIG. 1.

FIG. 4 is a top plan view of an example flexible homogeneous carbon polymeric heating element that may be used with the heating pad shown in FIGS. 2 and 3.

Corresponding reference numerals indicate corresponding parts throughout the several views of the drawings.

### DETAILED DESCRIPTION OF THE DISCLOSURE

The embodiments described herein provide systems and methods for heating equipment in a hazardous environment (e.g., in an environment including liquid gas pipelines). A system includes a control system configured to receive power from a power source and a heating pad configured to heat the equipment. The heating pad includes at least one flexible semi-conductive self-regulating heating element and at least one thermal insulation layer positioned on one side of the at least one heating element. The heating pad further includes a protective cover, with the at least one heating element and the at least one thermal insulation layer sealed within the protective cover. The system further includes a power cable coupling the control system to the heating pad.

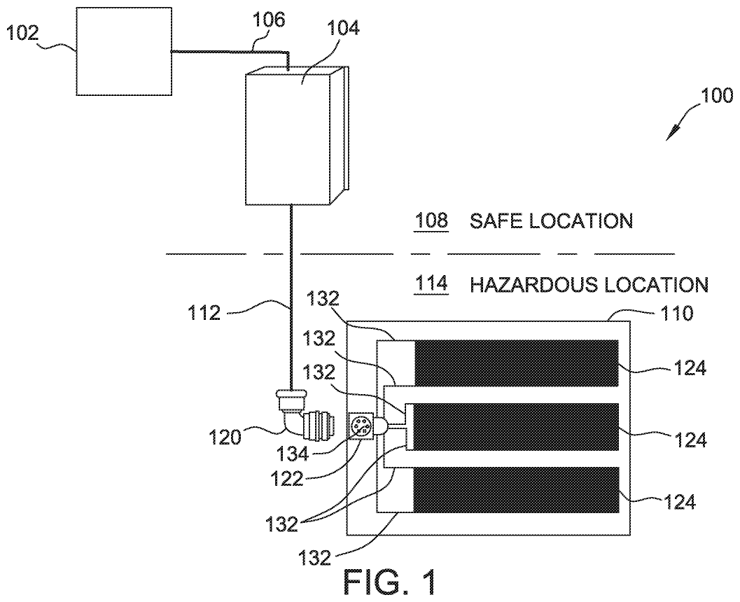

FIG. 1 is a schematic diagram of an example heating system 100. System includes a power source 102 electrically coupled to a control system 104 using a first power cable 106. Power source 102 and control system 104 are located in a safe (e.g., non-hazardous) location 108. Control system 104 is electrically coupled to a heating pad 110 using a second power cable 112. Power source 102 supplies power to control system 104, which in turn supplies power to heating pad 110. In one embodiment, control system 104 receives power from power source 102 at 120 Volts, and converts the received power such that power is supplied to heating pad 110 at 10-15 Volts (for example, power may be supplied to active barrier circuitry at approximately 12-15 Volts, and subsequently provided to heating pad 110 at approximately 10 Volts). Alternatively, power supplied to control system 104 and heating pad 110 may have any voltage that enables system 100 to function as described herein.

In the exemplary embodiment, heating pad 110 is located in a hazardous location 114. For example, heating pad 110 may be located in an environment containing liquid gas pipelines. As shown in FIG. 1, in the exemplary embodiment, second power cable 112 includes a cable connector 120 that engages a pad connector 122 on heating pad 110.

Heating pad 110 includes one or more flexible semi-conductive self-regulating heating elements 124 that generate heat at a predetermined temperature, as described herein. Heating pad 110 may be used, for example, to protect pipes and/or valves from freezing. Heating pad 110 may also be used to maintain a constant flow temperature in hot water systems, or to maintain process temperatures for piping that transports substances that solidify at ambient temperatures (e.g., liquid gas).

The temperature of heating pad 110 may be set using control system 104. For example, a user may operate control system 104 (e.g., via a user interface) to enter and/or select the temperature that heating pad 110 should be set at. Control system 104 controls the power supplied to heating pad 110 to achieve the predetermined temperature. In one embodiment, the predetermined temperature is approximately 104° F. Alternatively, heating pad 110 may be settable to any temperature that enables system 100 to function as described herein.

In the exemplary embodiment, control system 104 also includes active barrier circuitry. Specifically, control system 104 includes circuitry that facilitates isolating control system 104 from heating pad 110 in the event of a fault, to provide protection to heating pad 110.

In the exemplary embodiment, heating pad 110 includes three flexible, semi-conductive, self-regulating heating elements 124. Alternatively, heating pad 110 may include any number of heating elements 124 that enables system 100 to function as described herein. Two wires 132 connect each heating element 124 to pad connector 122, for a total of six wires 132 connected to pad connector 122. Accordingly, in this embodiment, pad connector 122 has six electrical contacts 134 (one for each wire 132) that electrically couple to cable connector 120. Each electrical contact 134 may be, for example, a male contact (e.g., a pin) that engages a corresponding female contact (e.g., a socket) formed in cable connector 120. Further, cable connector 120 and pad connector 122 are threadably coupled to one another, and are sealed to withstand moisture, condensation, vibration, and flash-over. Alternatively, cable connector 120 and pad connector may have any connection configuration that enables system 100 to function as described herein.

Wires 132 connect to bus conductors (not shown in FIG. 1) embedded in each heating element 124 to power to heating elements 124 and cause heat to be generated by heating elements 124. In the exemplary embodiment, each heating element 124 receives power at 8 Watts. Alternatively, each heating element 124 may receive power at any current that enables heating pad 110 to function as described herein.

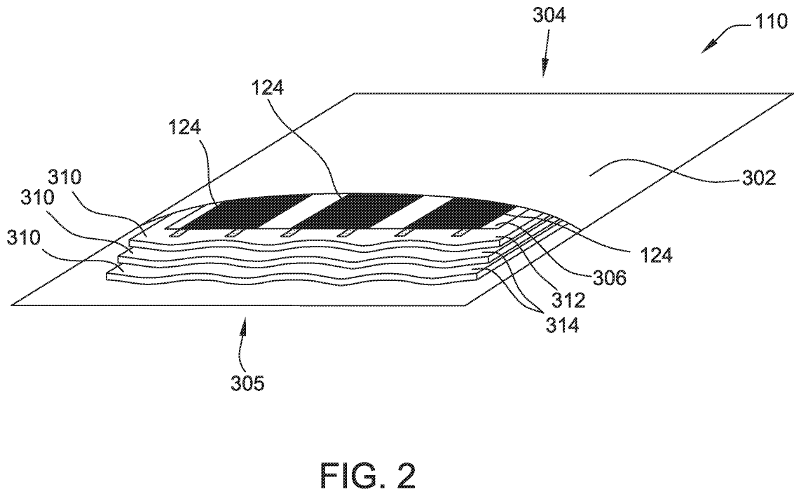

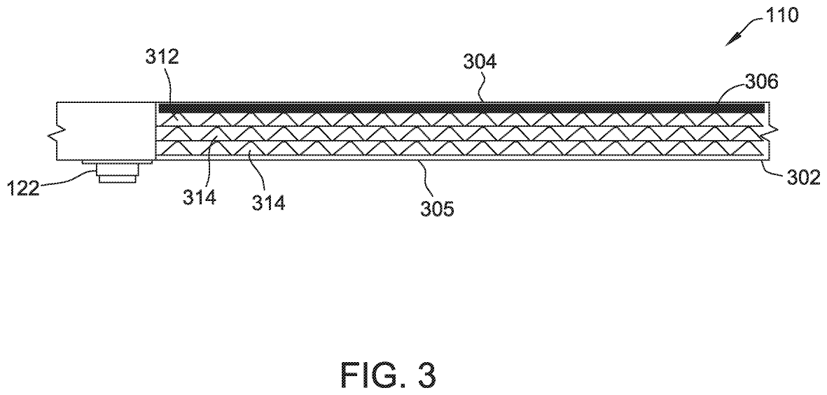

FIG. 2 is a perspective partial cut-away view of heating pad 110, and FIG. 3 is a cross-sectional view of heating pad 110. As shown in FIGS. 2 and 3, heating pad 110 includes a plurality of layers sealed within a protective cover 302. Protective cover 302 may be, for example, a vinyl polyester cover. Alternatively, protective cover 302 may be made of any suitable material. Heating pad 110 includes a top 304 and a bottom 305. As explained below, heat generated by heating pad 110 generally exits top 304. Accordingly, when heating pad 110 is applied to or wrapped around a surface to be heated (e.g., a pipe or valve), heating pad 110 is positioned such that top 304 contacts the surface to be heated.

As shown in FIGS. 2 and 3, heating elements 124 are embedded in a liner 306. In the exemplary embodiment, liner 306 is a polyethylene liner. Alternatively, liner 306 may be any material that enables heating pad 110 to function as described herein. Further heating elements 124 are spaced approximately 10 millimeters (mm) apart from one another in the exemplary embodiment. Alternatively, any suitable spacing between heating elements 124 may be used.

A plurality of thermal insulation layers 310 are positioned below liner 306. In the exemplary embodiment, thermal insulation layers 310 include a first insulation layer 312 positioned immediately below liner 306, and two second insulation layers 314 positioned immediately below first insulation layer 312. First insulation layer 312 is a polyethylene insulation layer, and second insulation layers 314 are each a polypropylene or foil (e.g., aluminum) insulation layer in the exemplary embodiment. Further, each layer has a thickness of approximately 10 mm. Alternatively, heating pad 110 may include any suitable number and/or composition of layers having any dimensions that enable heating pad 110 to function as described herein. Because insulation layers 310 are positioned below liner 306, heat generated by heating elements 124 is directed out through top 304 (instead of out through bottom 305), increasing the heat provided to a surface in contact with top 304. In the embodiment shown in FIG. 3, pad connector 122 extends from bottom 305 of heating pad 110. Alternatively, pad connector 122 may extend from top 304 of heating pad 110.

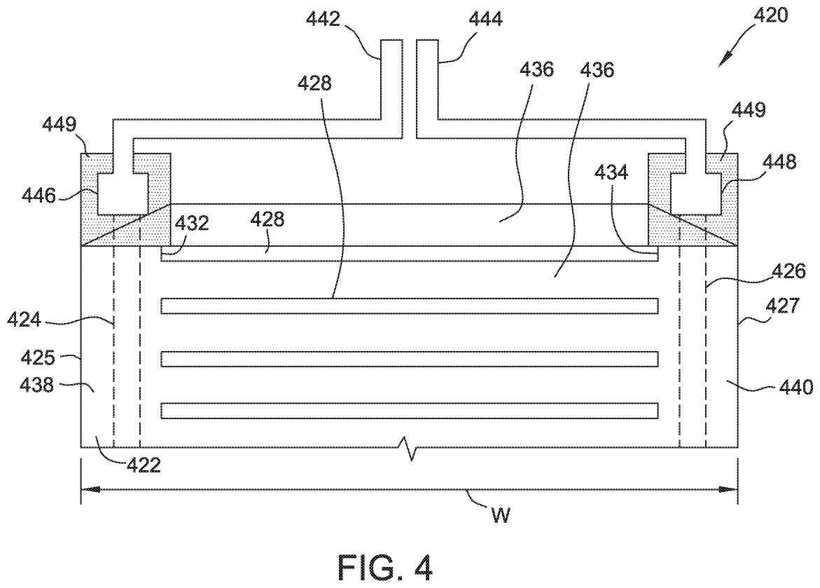

FIG. 4 is a top plan view of an example flexible homogeneous carbon polymeric heating element 420 that may be used as heating element 124. Heating element 420 includes an elongate web 422 of a flexible, electrically conductive plastic. In the exemplary embodiment, a polymeric dielectric film (not shown in FIG. 4) is applied to elongate web 422 to protect and insulate elongate web 422.

In the exemplary embodiment, elongate web 422 is a semi-conductive polymer including polyethylene mixed with carbon black, and has a thickness between 1.0 millimeters (mm) and 1.5 mm, such as approximately 1.10 millimeters (mm). Alternatively, elongate web 422 may be made of any material and have any thickness that enables elongate web 422 to function as described herein. In the example embodiment, heating element 420 has a width, W, between 7 centimeters (cm) and 35 cm, a thickness, T, between 1.0 mm and 1.5 mm, and may be as long as approximately 100 meters (m). For example, heating element 420 may have a width of approximately 15 cm, 23 cm, or 30 cm for embodiments including slots 428, and may have a width of approximately 5 cm or 7 cm for embodiments not including slots 428. Alternatively, heating element 420 may have any dimensions that enable heating element 420 to function as described herein. For example, the length may be calculated and designed for specific applications of heating element 420.

A first bus conductor 424 extends adjacent a first side 425 of elongate web 422, and a second bus conductor 426 extends adjacent a second side 427 of elongate web 422. First and second bus conductors 424 and 426 are embedded in elongate web 422, and are electrically connectable to wires 132. First and second bus conductors 424 and 426 each may be, for example, a braided wire (e.g., a tinned copper wire). In some embodiments, heating element 420 may include additional bus conductors.

In one exemplary embodiment, elongate web 422, and accordingly, heating element 420, has a plurality of transversely extending slots 428 defined therein. Slots 428 extend substantially across a width of heating element 420 and preferably have a constant width, except at their ends 432 and 434. Slots 428 define a plurality of transversely extending “rungs” 436 that extend between longitudinally extending “rails” 438 and 440. First bus conductor 424 is embedded in elongate web 422 at rail 438, and second bus conductor 426 is embedded in elongate web 422 at rail 440. Alternatively, in some embodiments, heating element 420 does not include slots 428.

Lead wires 442 and 444 (e.g., wires 132 (shown in FIG. 1)) are physically secured to heating element 420 and electrically connected to bus conductors 424 and 426, respectively, using crimp connectors 446 and 448. As shown in FIG. 4, to connect lead wire 442 and 444 to bus conductors 424 and 426, portions of heating element 420 may be removed (e.g., cut using scissors) at corner regions 449 to expose a portion of bus conductors 424 and 426.

Notably, if a temperature of heating element 420 increases, a resistance of elongate web 422 increases, decreasing a current and thus an amount of heat being generated. If the temperature of heating element 420 decreases, the resistance of elongate web 422 decreases, increasing a current and thus an amount of heat being generated. That is, heating element 420 has a positive temperature coefficient. Accordingly, heating element 420 is substantially self-regulating to facilitate ensuring stable operation at the predetermined temperature. This facilitates reducing power consumption and eliminating risks of overheating. Further, heating element 420 provides even heat distribution with no hot spots.

As described above, heating pad 110 may be wrapped around a pipe or valve to facilitate heating the pipe or valve. Accordingly, in some embodiments, first and second edges of heating pad 110 are attachable to one another when heating pad 110 is wrapped around the pipe or valve. For example, first and second edges may include adhesives, hook and loop fasteners, or any other coupling mechanisms for attaching heating pad 110 to itself when heating pad 110 is wrapped around a pipe or valve.

The systems and methods described herein may be used to heat pipelines or valves in industrial systems, such as gas pipelines. For example, in a liquid gas pipeline, if there is a reduction in flow of the liquid gas or a change in pressure or the liquid gas, at least a portion of the liquid gas may solidify, reducing throughput. Accordingly, the heating pad described herein may be applied to a pipeline to prevent solidification or to reverse solidification that has already occurred.

At least some known pipeline heating systems require a temperature sensor at the pipeline (i.e., in the hazardous environment). Further, it may be costly and inefficient to transmit sensor readings from the temperature sensor to a control system, as the control system may be located relatively far from the pipeline. In contrast, as described above, the heating pad in the embodiments described herein is self-regulating, so no temperature sensor is required.

The heating pad described herein is easily replaceable, and can easily be moved or added when more heat is required. The heating pad is also flexible, and can easily be bent 90 degrees to fit any contour when warm. Further, the systems and methods described herein are versatile, and can be used in commercial or industrial applications. For example, the embodiments described herein may be used as an ice prevention system (e.g., to prevent ice from forming on pipelines, valves, manifolds, and other equipment), as a heat control system (e.g., to maintain fluid temperature in pipelines, tanks, and other containers), and may be used in hazardous locations. Thus, the systems and methods described herein reduce the effects of low ambient temperature that may cause operational failures and interruption of production.

The embodiments described also provide intrinsically safe systems and methods for heating components in hazardous environments. Specifically, operation of the heating pad described herein will not result in igniting flammable gases, because the heating pad is self-regulating, and because no conductive elements of the heating pad are exposed to the ambient environment.

Example embodiments of systems and methods for heating equipment in hazardous environments are described above in detail. The systems and methods are not limited to the specific embodiments described herein, but rather, components of the systems and methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for heating equipment in a hazardous environment, said system comprising:
a control system configured to receive power from a power source;
a heating pad configured to heat the equipment, said heating pad comprising:
at least one heating element, wherein said at least one heating element is a flexible semi-conductive self-regulating heating element;
at least one thermal insulation layer positioned on one side of said at least one heating element; and
a protective cover, wherein said at least one heating element and said at least one thermal insulation layer are sealed within said protective cover; and
a power cable coupling said control system to said heating pad.

2. A system in accordance with claim 1, wherein said control system is configured to:
receive a user input specifying a predetermined temperature; and
control said heating pad to operate at the predetermined temperature.

3. A system in accordance with claim 1, wherein said at least one thermal insulation layer comprises a first insulation layer made of a first material and two second insulation layers made of a second material.

4. A system in accordance with claim 1, wherein said control system comprises active barrier circuitry that facilitates isolating said control system from said heating pad in the event of a fault.

5. A system in accordance with claim 1, wherein said heating pad is configured to be wrapped around a pipeline.

6. A system in accordance with claim 1, wherein said at least one heating element comprises three heating elements.

7. A system in accordance with claim 1, wherein said protective cover is a vinyl polyester cover.

8. A system in accordance with claim 1, wherein said power cable comprises a cable connector, and wherein said heating pad comprises a pad connector configured to engage said cable connector.

9. A system in accordance with claim 1, wherein a plurality of slots are defined through said at least one heating element.

10. A heating pad for heating equipment in a hazardous environment, said heating pad comprising:
at least one heating element, wherein said at least one heating element is a flexible semi-conductive self-regulating heating element;
at least one thermal insulation layer positioned on one side of said at least one heating element; and
a protective cover, wherein said at least one heating element and said at least one thermal insulation layer are sealed within said protective cover.

11. A heating pad in accordance with claim 10, wherein said at least one thermal insulation layer comprises a first insulation layer made of a first material and two second insulation layers made of a second material.

12. A heating pad in accordance with claim 10, wherein said heating pad is configured to be wrapped around a pipeline.

13. A heating pad in accordance with claim 10, wherein said at least one heating element comprises three heating elements.

14. A heating pad in accordance with claim 10, wherein said protective cover is a vinyl polyester cover.

15. A heating pad in accordance with claim 10, said heating pad comprises a pad connector configured to engage a cable connector of a power cable.

16. A heating pad in accordance with claim 10, wherein a plurality of slots are defined through said at least one heating element.
